(19) United States
(12) Patent Application Publication
(10) Pub. No.: US 2020/0328580 A1
(43) Pub. Date: Oct. 15, 2020

(54) GAS-INSULATED SWITCHGEAR

(71) Applicant: Mitsubishi Electric Corporation, Chiyoda-ku, Tokyo (JP)

(72) Inventor: Naoaki INOUE, Tokyo (JP)

(73) Assignee: Mitsubishi Electric Corporation, Chiyoda-ku, Tokyo (JP)

(21) Appl. No.: 16/639,665

(22) PCT Filed: Nov. 16, 2018
(86) PCT No.: PCT/JP2018/042526

§ 371 Date: Feb. 17, 2020

(30) Foreign Application Priority Data
Dec. 22, 2017 (JP) 2017-245815

(51) Int. Cl. H02B 13/00; H02B 1/20; H02B 13/035

(52) U.S. Cl. CPC H02B 13/005; H02B 13/0358; H02B 1/20

(57) ABSTRACT

Provided is a gas-insulated switchgear that facilitates additional installation work and achieves reduction in working time in the case of increasing arranged boards in additional installation of open/close devices. A bus tank storing a bus is provided above a circuit breaker tank storing a circuit breaker, the bus is connected to a bus connection bushing provided at a width-direction end of the bus tank, a tank width dimension of the bus tank is smaller than an enclosure width dimension of the gas-insulated switchgear, and a space formed by a difference between the enclosure width dimension and the tank width dimension serves as a connection space for the bus when the gas-insulated switchgear is arranged in a row.

### TECHNICAL FIELD

The present disclosure relates to a gas-insulated switchgear, and in particular, relates to a bus connection structure thereof.

### BACKGROUND ART

A gas-insulated switchgear has SF6 gas sealed therein, and the device is made compact owing to excellent insulation property of the SF6 gas, thus contributing to space saving in an electrical room. The gas-insulated switchgear is normally configured such that boards for various purposes such as a receiving board and a feeder board are arranged in a row and these boards are connected via buses. Regarding the bus part, a gas bus type is generally adopted in which, when the gas-insulated switchgear is installed, a bus tank is connected, and a bus conductor in the bus tank is connected.

In recent years, there has been a case where a solid insulating bus is used to omit an on-site gas processing work when the gas-insulated switchgear is installed. For example, above a mold unit having an interruption portion and a disconnection portion integrated in a mold, solid insulation buses for three phases are arranged in the left-right direction as seen from the front side of a switchgear (see, for example, Patent Document 1).

### CITATION LIST

### Patent Document

Patent Document 1: Japanese Laid-Open Patent Publication No. 2017-93133 (page 8, FIGS. 1, 2, and 8)

### SUMMARY OF THE INVENTION

### Problems to be Solved by the Invention

As described above, it is possible to omit gas processing work when the gas-insulated switchgear is installed on site, by using a solid insulation bus for the bus part of the gas-insulated switchgear. In the case of a solid insulation bus structure as in Patent Document 1, a bus connection bushing is provided at an upper part of each board of the switchgear, and the solid insulation bus is provided above that. Therefore, in the case where a plurality of open/close devices are arranged in a row, solid insulation buses connecting the arranged boards are located above the plurality of open/close devices so as to pass over the arranged boards.

In such a configuration, in the case of adding an open/close device, it is necessary to perform work in which the buses are powered off, all the solid insulation buses above the already provided boards are detached, the additional board is arranged in a row, and then the solid insulation buses including the one for the additional board are attached again. The reason is as follows. In the solid insulation bus structure as in Patent Document 1, the buses are arranged so as to pass over the arranged boards. Therefore, it is impossible to detach only the solid insulation bus for one panel, and it is necessary to detach all the buses at the same time. Thus, there is a problem that working for additional installation takes a long time.

The present disclosure has been made to solve the above problem, and an object of the present disclosure is to obtain a gas-insulated switchgear that facilitates bus connection work and achieves reduction of working time in the case of increasing arranged boards in additional installation or the like.

### Solution to the Problems

A gas-insulated switchgear according to the present disclosure is a gas-insulated switchgear in which a bus tank storing a bus is provided above a circuit breaker tank storing a circuit breaker, wherein the bus is connected to a bus connection bushing provided at a width-direction end of the bus tank, a tank width dimension of the bus tank is smaller than a enclosure width dimension of the gas-insulated switchgear, and a space formed by a difference between the enclosure width dimension and the tank width dimension serves as a connection space for the bus when the gas-insulated switchgear is arranged in a row.

### Effect of the Invention

In the gas-insulated switchgear according to the present disclosure, the tank width dimension of the bus tank storing the bus is smaller than the enclosure width dimension of the gas-insulated switchgear, and the space formed by the difference between the enclosure width dimension and the tank width dimension serves as the connection space for the bus when the gas-insulated switchgear is arranged in a row. Therefore, in the case of performing work of connecting buses with an adjacent board to be arranged in a row, the buses of both adjacent boards can be easily connected using the connection space. Thus, it becomes possible to reduce the working time.

### BRIEF DESCRIPTION OF THE DRAWINGS

FIG. 1 is a side sectional view of a gas-insulated switchgear according to embodiment 1.

FIG. 2 is a top view of FIG. 1.

FIG. 3 is a sectional view of a solid insulation bus adapter of the gas-insulated switchgear according to embodiment 1.

FIG. 4 is a sectional view showing a state in which bus connection bushings are inserted into the solid insulation bus adapter shown in FIG. 3.

FIG. 5A is a sectional view showing a plug-in contactor used for a bus contact engagement portion shown in FIG. 4.

FIG. 5B is a sectional view showing a plug-in contactor used for a bus contact engagement portion shown in FIG. 4.

FIG. 6 is a top view showing a process when gas-insulated switchgears for two panels are arranged in a row, according to embodiment 1.

FIG. 7 is a top view showing a state in which two-panel board arrangement is completed after the state shown in FIG. 6.

FIG. 8 is a top view showing a state in which the solid insulation bus adapters and insulating plugs are attached after two-panel arrangement shown in FIG. 7.

FIG. 9 is a top view showing a state in which gas-insulated switchgears for three panels are arranged in a row, according to embodiment 1.

FIG. 10 is a single-line diagram of FIG. 9.

FIG. 11 is a single-line diagram showing a state in which gas-insulated switchgears for two panels are arranged in a row, according to embodiment 2.

FIG. 12 is a single-line diagram showing a state in which gas-insulated switchgears for three panels are arranged in a row, according to embodiment 2.

FIG. 13A is a single-line diagram showing a gas-insulated switchgear according to embodiment 3.

FIG. 13B is a front view showing a gas-insulated switchgear according to embodiment 3.

### DESCRIPTION OF EMBODIMENTS

### Embodiment 1

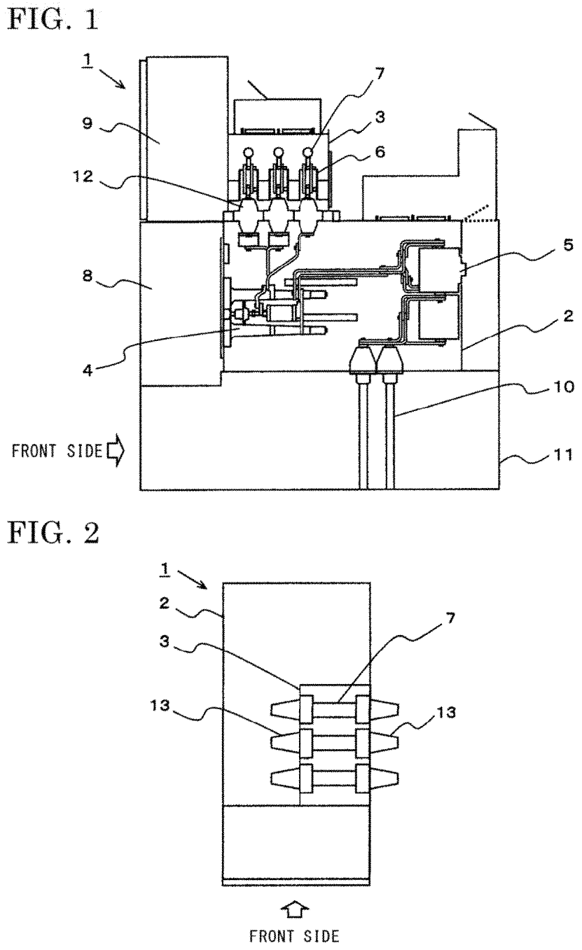

FIG. 1 is a side sectional view of a gas-insulated switchgear according to embodiment 1.FIG. 2 is a top view of the gas-insulated switchgear 1 shown in FIG. 1, as seen from above, and mainly shows the cross section of a bus tank portion at an upper part and a connection portion thereof, while parts not directly relevant to the present disclosure are not shown (the same applies to the other top views). In FIG. 1, the left side in the drawing is the front side, and in FIG. 2, the direction is rotated by 90 degrees so that the lower side is the front side. Therefore, the left-right direction in FIG. 1 corresponds to the depth direction of a switchgear enclosure of the gas-insulated switchgear, and the left-right direction in FIG. 2 corresponds to the width direction of the switchgear enclosure.

As shown in FIG. 1, the gas-insulated switchgear 1 has a circuit breaker tank 2 and a bus tank 3 located above the circuit breaker tank 2. Inside the circuit breaker tank 2 in which insulation gas is sealed, a circuit breaker 4 and an instrument current transformer 5 are provided. Inside the bus tank 3 in which insulation gas is also sealed, disconnectors 6 and buses 7 are provided. An operation chamber 8 storing an operation mechanism and the like is provided in front of the circuit breaker tank 2, a control chamber 9 storing a control device and the like is provided above the operation chamber 8, and a cable chamber 11 storing a power cable 10 is provided under the circuit breaker tank 2.

The movable side of the circuit breaker 4 is connected to the buses 7 via bushings 12 provided at a partition part between the circuit breaker tank 2 and the bus tank 3, and via the subsequent disconnectors 6. The fixed side of the circuit breaker 4 is connected to the power cable 10 via a connection conductor and the instrument current transformer 5 provided at a certain part on the connection conductor.

The internal structures of the circuit breaker tank 2 and the cable chamber 11 are merely examples, and are not limited to those shown in the drawing.

As shown in the top view in FIG. 2, the tank width dimension of the bus tank 3 provided above the circuit breaker tank 2 is set to be smaller than the enclosure width dimension of the gas-insulated switchgear 1, and this is a characteristic part of the present disclosure.

Inside the bus tank 3, the buses 7 for three phases are arranged in parallel along the switchgear width direction. Bus connection bushings 13 are provided at tank wall penetration portions at both ends of the buses 7, and the buses 7 are supported by being connected to the bus connection bushings 13.

In the case where boards are arranged in a row, i.e., a plurality of gas-insulated switchgears 1 are arranged side by side in the width direction, for example, the buses of the gas-insulated switchgear located at the left in FIG. 2 are connected to the bus connection bushings 13 on the left side of the bus tank 3. The buses of the gas-insulated switchgear located at the right are connected to the bus connection bushings 13 on the right side of the bus tank 3.

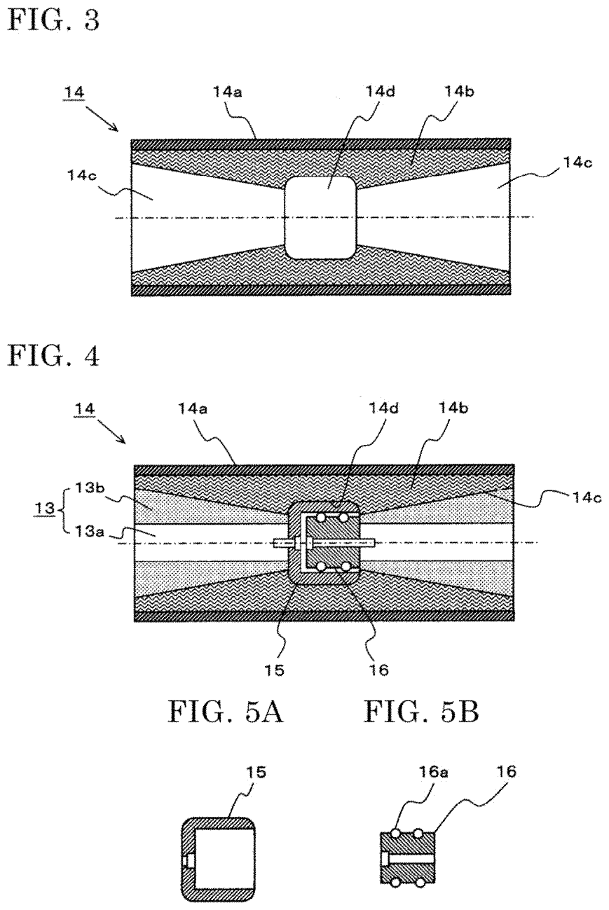

FIG. 3 is a sectional view showing a solid insulation bus adapter 14 used for a part connecting the buses of the respective boards arranged in a row. The entire body thereof has a cylindrical shape, the outer surface is formed to be a surface conductive layer 14a, and an internal insulating layer 14b is formed on the inner side thereof. The internal insulating layer 14b is formed by an elastic insulating material such as rubber, for example. On the inner diameter side, plug-in portions 14c are formed in a tapered shape having a diameter decreasing toward the center from both end sides in the longitudinal direction, and a bus contact engagement portion 14d is formed in a straight shape at the center part.

FIG. 4 is a sectional view showing a state in which the bus connection bushings 13 are inserted into the solid insulation bus adapter 14.

The bus connection bushings 13 are fitted to the plug-in portions 14c, and a plug-in contactor recess 15 and a plug-in contactor projection 16 described below are inserted into the bus contact engagement portion 14d. The procedure for attaching these will be described later.

Of each bus connection bushing 13, the part protruding outward of the bus tank 3 has a conductor portion 13a at the center and an insulating portion 13b coating the outer surface thereof. The insulating portion 13b has a conical shape tapered toward the tip end, and this part is fitted to the plug-in portion 14c.

It is noted that, of the bus connection bushing 13, the part attached to the bus tank 3 and the inward side are not shown in the drawing.

FIGS. 5A and 5B are sectional views showing the plug-in contactor projection 16 and the plug-in contactor recess 15 inserted into the bus contact engagement portion 14d. The plug-in contactor recess 15 has a hollow cylindrical shape, one end side thereof is formed to be an attachment surface to the bus connection bushing 13, and an attachment hole is formed at the center part. The plug-in contactor projection 16 has a cylindrical shape, one end side thereof is formed to be an attachment surface to the bus connection bushing 13, and an attachment hole is formed at the center part. In addition, a contactor portion 16a is provided on the outer circumferential surface. The contactor portion 16a comes into contact with the inner circumferential surface of the hollow part of the plug-in contactor recess 15, so as to serve as a current conduction portion.

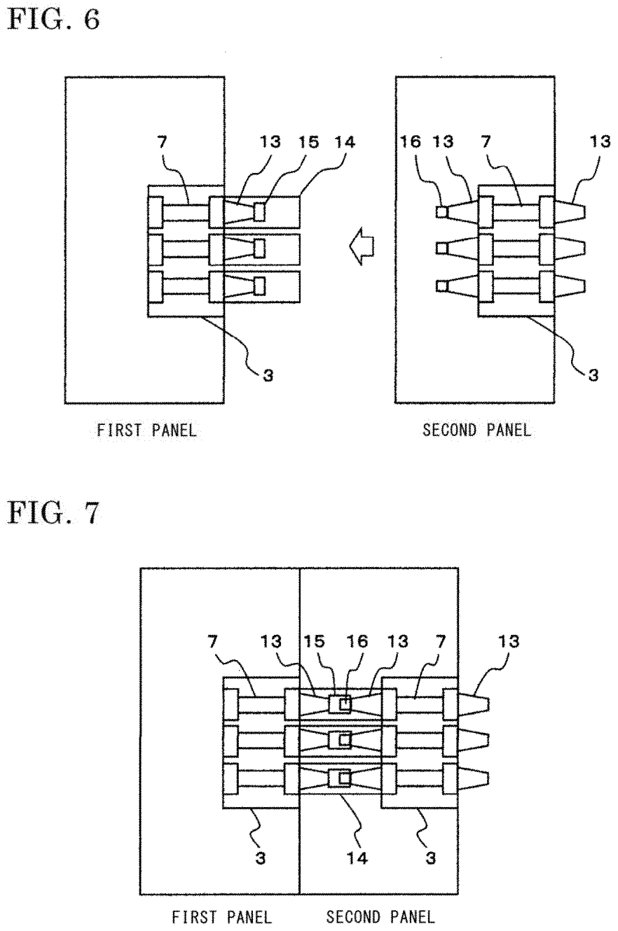

FIG. 6 is a top view showing a process when the gas-insulated switchgears 1 are arranged in a row, and shows only major parts relevant to the present disclosure. The first board is referred to as “first panel”, and the board to be added is referred to as “second panel”. After the board for the first panel is fixed, the plug-in contactor recesses 15 are attached to the bus connection bushings 13 of the first panel by means of bolt-fastening or the like, and then the solid insulation bus adapters 14 are fitted and attached thereto. Since the internal insulating layer 14b of the solid insulation bus adapter 14 is formed by an elastic material, it is possible to fit the solid insulation bus adapter 14 in a state in which the plug-in contactor recess 15 is attached.

In the case where no board is planned to be arranged at the left of the board for the first panel, the bus connection bushings 13 on the left side of the bus tank 3 for the first panel need not protrude in a conical shape on the outward side, and are only required to have a structure for supporting ends of the buses 7.

In the board for the second panel, the plug-in contactor projections 16 are attached to the bus connection bushings 13 on the left side of the bus tank 3 by means of bolt-fastening or the like. Then, the board for the second panel is slid in the direction toward the board for the first panel, whereby both boards are arranged in a row and at the same time, the bus connection bushings 13 for the first panel and the second panel are plugged in to both sides of the solid insulation bus adapters 14. Thus, bus connection is completed.

FIG. 7 is a top view showing a state in which board arrangement is completed. As shown in FIG. 7, the length of the solid insulation bus adapter 14 is set to be substantially equal to a length obtained by subtracting the tank width dimension of the bus tank 3 from the enclosure width dimension of the gas-insulated switchgear 1. In addition, the length of the part of the bus connection bushing 13 that protrudes outward of the bus tank 3 is set so as to be fitted to the solid insulation bus adapter 14. The solid insulation bus adapter 14 part serves as a solid insulation bus, and therefore, the state after the board arrangement is equivalent to a state in which the buses 7 of both boards are connected to each other via a solid insulation bus. As described above, the space formed by a difference between the enclosure width dimension of the gas-insulated switchgear 1 and the tank width dimension of the bus tank 3 is used as a space for connecting both buses when the boards are arranged in a row.

FIG. 6 and FIG. 7 above have shown the case of operation with two panels. Next, such a case where, for example, operation is initially performed with two panels and there is a plan of adding one panel at the right of the second panel in the future will be described.

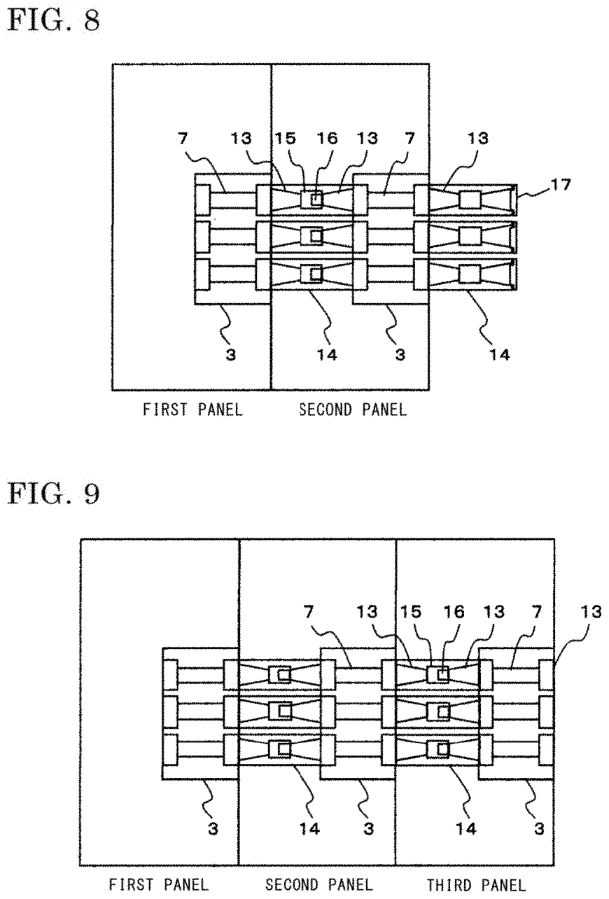

FIG. 8 is a top view showing the case where there is a plan of arranging another board after two-panel arrangement. The solid insulation bus adapters 14 and insulating plugs 17 are attached to the bus connection bushings 13 protruding rightward of the second panel. Thus, in preparation for additional installation in the future, the solid insulation bus adapters 14 are connected to the bus connection bushings 13 located on the side where additional installation is planned, and the insulating plugs 17 are attached to ends of the solid insulation bus adapters 14. Thus, it becomes possible to operate the open/close devices while insulating the bus ends of the second panel on the side where additional installation is planned.

FIG. 9 is a top view showing a state in which three panels are arranged in a row. In the case of additionally providing the third panel after the state shown in FIG. 8, the buses 7 are powered off, the insulating plugs 17 attached to the solid insulation bus adapters 14 on the right side of the second panel are detached, and the board for the third panel is arranged through the same procedure as in the case of the second panel described above, whereby the buses 7 of the third panel are connected.

In the case of further increasing arranged boards, the boards for the fourth and subsequent panels can be arranged in a row by the same method as described above. On the other hand, in the case where there is no plan of increasing boards any more, the bus connection bushings 13 on the outward side of the last end board need not protrude in a conical shape.

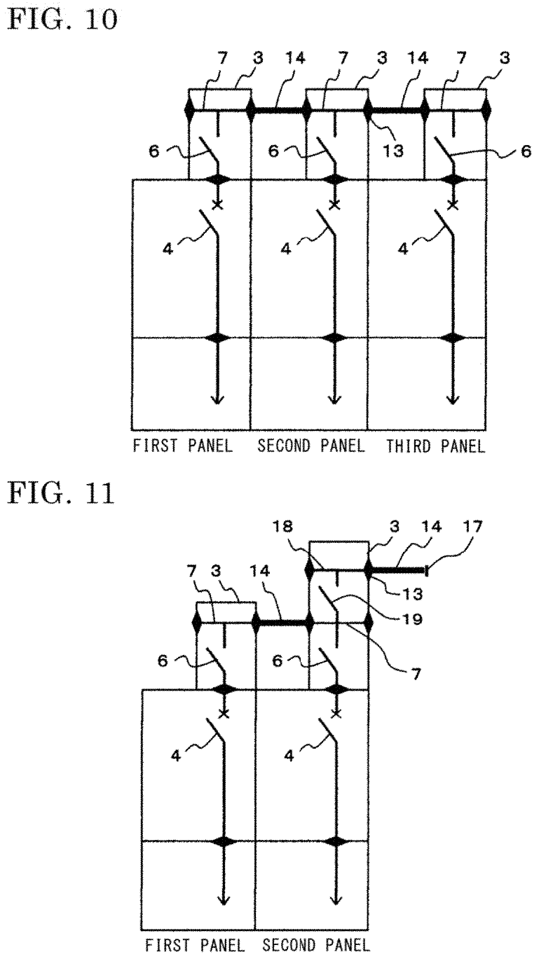

FIG. 10 is a single-line diagram corresponding to FIG. 9, in the case where boards for three panels are arranged in a row.

In the conventional gas-insulated switchgear as shown in Patent Document 1, for example, it is necessary to detach all the insulation buses of the already provided boards, arrange an additional board in a row, and then attach the insulation buses again. In contrast, in the present embodiment, at the time of additional installation, the insulating plugs 17 at the end board are merely detached, and large-scale work is not performed on the already provided boards. Thus, it is possible to greatly reduce the working time.

FIG. 2 and FIG. 6 to FIG. 9 have shown the case where the provided position of the bus tank 3 in the switchgear width direction is located to the right side as seen from the front side. However, the provided position of the bus tank 3 in the switchgear width direction is not limited to that shown in the drawings. For example, the bus tank 3 may be located at the left side or the center in the switchgear width direction.

As described above, in the gas-insulated switchgear according to embodiment 1, a bus tank storing a bus is provided above a circuit breaker tank storing a circuit breaker, the bus is connected to a bus connection bushing provided at a width-direction end of the bus tank, a tank width dimension of the bus tank is smaller than a enclosure width dimension of the gas-insulated switchgear, and a space formed by a difference between the enclosure width dimension and the tank width dimension serves as a connection space for the bus when the gas-insulated switchgear is arranged in a row. Therefore, in the case of performing work of connecting buses with an adjacent board to be arranged in a row, the buses of both adjacent boards can be easily connected using the connection space. Thus, it becomes possible to reduce the working time.

In addition, in the case where the gas-insulated switchgears are arranged in a row, the bus connection bushings of the adjacent boards are connected to each other via the solid insulation bus adapters in the connection space. Therefore, at the time of board arrangement, it is possible to easily connect the buses and arrange the boards in a row, without detaching the insulation buses at the already provided boards. In addition, the state after board arrangement is equivalent to a state in which the buses are connected via solid insulation buses.

In addition, the solid insulation bus adapters are connected to the bus connection bushings, and the insulating plugs are provided at the ends of the solid insulation bus adapters. Therefore, in the case of performing additional installation work in the future, it is possible to easily connect the buses to the additional board by detaching the insulating plugs of the solid insulation bus adapters, whereby the working time can be reduced.

### Embodiment 2

FIG. 11 is a single-line diagram showing a gas-insulated switchgear according to embodiment 2. FIG. 11 shows the case where two panels are arranged in a row, and the first panel is the same as that in embodiment 1. The present embodiment has a characteristic part in the gas-insulated switchgear for the second panel, while parts equivalent to those in the first panel are denoted by the same reference characters.

The bus connection between the first panel and the second panel is the same as in embodiment 1, and the connection is made using the solid insulation bus adapter 14 in the connection space on the lateral side of the bus tank 3. The structure described thus far is the same as in embodiment 1.

In the present embodiment, as shown in FIG. 11, inside the bus tank 3 for the second panel, a second bus 18 is provided in parallel to and separately from the same bus 7 as in embodiment 1. The second bus 18 is also supported by the bus connection bushing 13.

Inside the bus tank 3 of the board for the second panel, the bus 7 and the second bus 18 are connected via a second disconnector 19. The solid insulation bus adapter 14 is connected to the outward side of the bus connection bushing 13 on the right side of the second bus 18, and the second bus 18 is insulated by the insulating plug 17. It is noted that the second disconnector 19 part is not limited to a disconnector, that is, a switch is only required. In addition, although two buses are provided here, more than two buses may be provided.

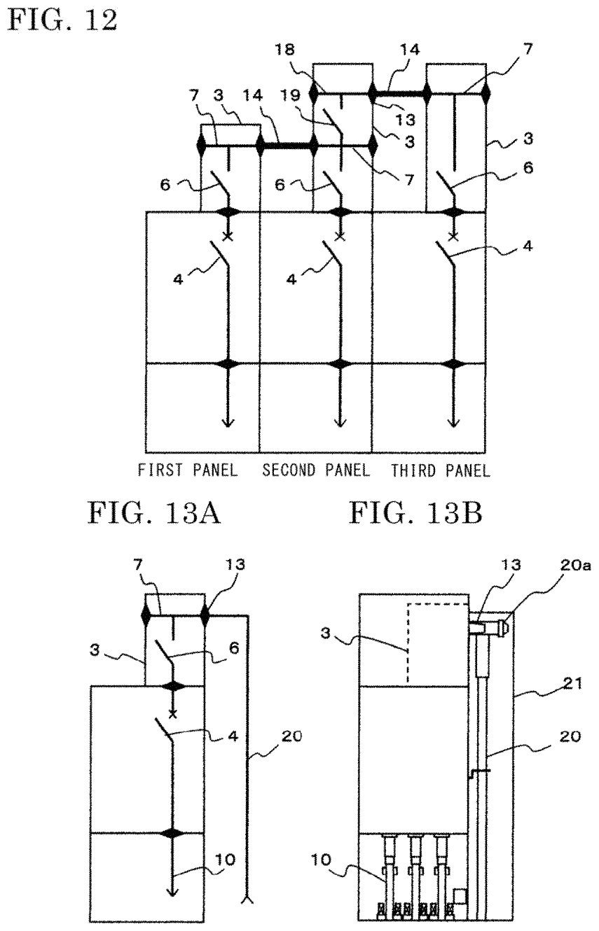

FIG. 12 is a single-line diagram showing a state in which the third panel is arranged in a row. In the third panel, the height of the bus tank 3 is set to be approximately equal to the height of the second panel, and the position of the bus 7 is matched with the position of the second bus 18 in the second panel. The other configurations are basically the same as in the first panel. Therefore, the same parts are denoted by the same reference characters and the description thereof is omitted.

In the case of additionally installing the third panel at the right of the second panel, first, the second disconnector 19 in the board for the second panel is switched “off” to disconnect the bus 7 and the second bus 18 in the board for the second panel, and the second bus 18 is grounded. In this way, in additional installation work, while the first panel and the second panel remain in operation without being powered off, the insulating plug 17 of the solid insulation bus adapter 14 connected to the second bus 18 is detached and the third panel is arranged in a row through the same procedure as for the second panel.

After additional installation, the disconnector 19 in the second panel and the disconnector 6 in the third panel are switched “on”, and then the circuit breaker 4 in the third panel is switched “on”, whereby the third panel is also energized and thus becomes able to operate.

As described above, in the gas-insulated switchgear according to embodiment 2, the buses stored in the bus tank are composed of a plurality of buses arranged in parallel, and the plurality of buses are connected to each other via a switch. Therefore, in the case of increasing the arranged board in additional installation, the switch is turned off, and the bus on the additional board side is grounded, whereby additional installation work can be performed in a state in which the buses at the already provided boards are energized.

### Embodiment 3

FIGS. 13A and 13B show a gas-insulated switchgear according to embodiment 3. FIG. 13A shows a single-line diagram, and FIG. 13B shows only major parts of the front view of the board corresponding to FIG. 13A.

The gas-insulated switchgear itself is basically the same as that described in embodiment 1. The bus connection bushing 13 is provided on the lateral side of the bus 7 stored in the bus tank 3. Here, a power cable 20 can be connected to the outward side of the bus connection bushing 13, and this is a characteristic part of the present embodiment. Therefore, the shape of a connection interface on the outward side of the bus connection bushing 13 to which the power cable 20 is connected is formed to be the same as the shape of an interface of a general cable connection portion. That is, the outward protruding side of the bus connection bushing 13 is formed in such a shape to which a cable head portion 20a of the power cable 20 can be fitted.

Thus, the cable head portion 20a of the power cable 20 can be directly connected to the bus connection bushing 13. A cable cover 21 for cable protection is provided so as to cover the power cable 20.

As shown in the single-line diagram in FIG. 13A, a path leading from the power cable 20 on the receiving side through the bus 7, the disconnector 6, and the circuit breaker 4 to the power cable 10 on the feeding side can be formed in one panel of the open/close device.

In the conventional switchgear, for example, in the case where a power cable is led into the switchgear from the lower side and then a feeding cable is led out downward through the switchgear, one more panel is added to the present board, buses are connected between the present board and the additional board, and the feeding cable is led out downward from the additional board side. Therefore, a space for two panels is needed, leading to increase in both cost and space. In contrast, in the present embodiment, the structure can be made with only one panel. As a matter of course, as in embodiment 1, a board may be additionally installed on the left side of the present board.

As described above, in the gas-insulated switchgear according to embodiment 3, the shape of a connection interface on the outward side of the bus connection bushing is formed to match an interface of a connection portion of a power cable, so as to allow the power cable to be directly connected to the bus connection bushing. Therefore, it is possible to easily connect the power cable on the receiving side without the need of a board for cable connection.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 gas-insulated switchgear

2 circuit breaker tank

3 bus tank

4 circuit breaker

5 instrument current transformer

6 disconnector

7 bus

8 operation chamber

9 control chamber

10 power cable

11 cable chamber

12 bushing

13 bus connection bushing

13a conductor portion

13b insulating portion

14 solid insulation bus adapter

14a surface conductive layer

14b internal insulating layer

14c plug-in portion

14d bus contact engagement portion

15 plug-in contactor recess

16 plug-in contactor projection

16a contactor portion

17 insulating plug

18 second bus

19 second disconnector

20 power cable

20a cable head portion

21 cable cover

1. A gas-insulated switchgear comprising a plurality of gas-insulated switchgears arranged in a row in a switchgear width dimension which is a width direction of a switchgear enclosure, the gas-insulated switchgears each including a circuit breaker tank storing a circuit breaker, and a bus tank provided above the circuit breaker tank and storing a bus, wherein
the bus tank of each of the gas-insulated switchgears arranged in a row is provided with bus connection bushings connected to the bus, at respective both ends in the switchgear width dimension.
a tank width dimension of the bus tank in the switchgear width dimension is smaller than an enclosure width dimension of the switchgear enclosure,
the bus connection bushings of the adjacent bus tanks are connected to each other via a first solid insulation bus adapter provided in a space formed by a difference between the enclosure width dimension and the tank width dimension, and
a second solid insulation bus adapter having an end to which an insulating plug is attached is connected to the bus connection bushing of the bus tank on a last end side to which an additional board is planned to be arranged in a row.

2. The gas-insulated switchgear according to claim 1, wherein
each solid insulation bus adapter has a conductive layer at a surface thereof and has an insulating layer on an inner side thereof.

3. The gas-insulated switchgear according to claim 1, wherein
each bus connection bushing is formed such that a part protruding outward of the bus tank has a conductor portion at a center and has an insulating portion covering an outer surface thereof, and the insulating portion has a conical shape tapered toward a tip end.

4. The gas-insulated switchgear according to claim 1, wherein
the bus stored in the bus tank comprises a plurality of buses arranged in parallel, and the plurality of buses are connected to each other via a switch.

5. The gas-insulated switchgear according to claim 2, wherein
each bus connection bushing is formed such that a part protruding outward of the bus tank has a conductor portion at a center and has an insulating portion covering an outer surface thereof, and the insulating portion has a conical shape tapered toward a tip end.

6. The gas-insulated switchgear according to claim 2, wherein
the bus stored in the bus tank comprises a plurality of buses arranged in parallel, and the plurality of buses are connected to each other via a switch.

7. The gas-insulated switchgear according to claim 3, wherein
the bus stored in the bus tank comprises a plurality of buses arranged in parallel, and the plurality of buses are connected to each other via a switch.
